(19) United States
(12) Patent Application Publication
(10) Pub. No.: US 2021/0293008 A1
(43) Pub. Date: Sep. 23, 2021

(54) WALL MOUNT BRACKET DEVICE IN WHICH HANGING DEVICE IS CONFIGURED TO BE REMOVED IN MULTIPLE DIRECTIONS

(71) Applicant: Xiamen Solex High-Tech Industries Co., Ltd., Xiamen (CN)

(72) Inventors: Zhichun LIN, Xiamen (CN); Donghai CHEN, Xiamen (CN); Rongren HONG, Xiamen (CN)

(21) Appl. No.: 17/204,133

(22) Filed: Mar. 17, 2021

(30) Foreign Application Priority Data
Mar. 17, 2020 (CN) 202010186266.5

(51) Int. Cl. E03C 1/06; B05B 1/18

(52) U.S. Cl. CPC E03C 1/06; B05B 1/185

(57) ABSTRACT

A wall mount bracket device comprises a wall mount bracket, a hanging device, and one or more positioning mechanisms. A hanging structure comprises a hanging groove penetrating up and down and a hanging portion protruding outward. The hanging portion cooperates with the hanging groove to enable the hanging portion and the hanging groove to move relative to each other up and down. The one or more positioning mechanisms comprise a positioning member, and the positioning member moves between a positioned state and a relief state due to an elastic force of the positioning member or an elastic body. When the positioning member is in the positioned state, the positioning member prevents the hanging device from falling downward under a weight of the hanging device. When the positioning member is in the relief state, the hanging device is configured to move downward relative to the wall mount bracket.

### RELATED APPLICATIONS

This application claims priority to Chinese patent application number 202010186266.5, filed Mar. 17, 2020. Chinese patent application 202010186266.5 is incorporated herein by reference.

### FIELD OF THE DISCLOSURE

The present disclosure relates to kitchen parts and bathroom parts, and in particular relates to a wall mount bracket device configured to remove a hanging device in multiple directions.

### BACKGROUND OF THE DISCLOSURE

Existing wall mount bracket devices, such as hand-held shower wall mount bracket devices, comprise a wall mount bracket and a hand-held shower, and the wall mount bracket is secured to the wall. The wall mount bracket comprises an insertion hole that penetrates up and down, and the insertion hole comprises an opening that penetrates both in and out and up and down. An inner wall of the insertion hole narrows from top to bottom, and the hand-held shower is detachably disposed in the insertion hole. The hand-held shower can be locked and positioned by its own weight due to the narrowing layout. The hand-held shower is locked by its own weight, and the hand-held shower can be only upwardly removed. Since the hand-held shower can be only removed in one direction, inconvenience is brought to the user.

### BRIEF SUMMARY OF THE DISCLOSURE

The present disclosure provides a wall mount bracket device in which a hanging device is configured to be removed in multiple directions, which overcomes the deficiencies of the wall mount bracket device in the background.

In order to solve the aforementioned technical problems, a technical solution of the present disclosure is as follows.

A wall mount bracket device in which a hanging device is configured to be removed in multiple directions comprises a wall mount bracket, a hanging device, and one or more positioning mechanisms. A hanging structure is disposed between the wall mount bracket and the hanging device. The hanging structure comprises a hanging groove penetrating up and down and a hanging portion protruding outward. The hanging portion cooperates with the hanging groove to enable the hanging portion and the hanging groove to move relative to each other up and down. The one or more positioning mechanisms comprise a positioning member, and the positioning member is configured to move between a positioned state and a relief state due to an elastic force of the positioning member or an elastic body. When the positioning member is in the positioned state, the positioning member prevents the hanging device from falling downward under a weight of the hanging device. When the positioning member is in the relief state, the hanging device is configured to move downward relative to the wall mount bracket.

In an embodiment, the hanging groove is disposed on the wall mount bracket, and a rear surface of the hanging device protrudes to define the hanging portion.

In an embodiment, the hanging groove is disposed on a rear surface of the hanging device, and a front surface of the wall mount bracket protrudes to define the hanging portion.

In an embodiment, the positioning member is disposed on the hanging groove. When the positioning member is in the positioned stated, the positioning member is disposed in the hanging groove, and the positioning member cooperates with the hanging portion to prevent the hanging device from falling downward under the weight of the hanging device.

In an embodiment, the positioning member is disposed on the hanging device, and the hanging groove comprises a protrusion. When the positioning member is in the positioned state, the positioning member cooperates with the protrusion to prevent the hanging device from falling downward under the weight of the hanging device.

In an embodiment, the positioning member is configured to be elastically deformed to enable the positioning member to be reset from the relief state to the positioned state.

In an embodiment, the one or more positioning mechanisms comprise the elastic body, and the elastic body abuts the positioning member to enable the positioning member to move to the positioned state due to the elastic force of the elastic body.

In an embodiment, the wall mount bracket device comprises a guiding mechanism. When the hanging device is downwardly pulled out, the positioning member moves from the positioned state to the relief state due to the guiding mechanism.

In an embodiment, the positioning member is disposed on the wall mount bracket, and the guiding mechanism is disposed between the hanging device and the positioning member.

In an embodiment, the positioning member is disposed on the hanging device, and the guiding mechanism is disposed between the wall mount bracket and the positioning member.

In an embodiment, the hanging groove comprises a positioning groove and an opening in communication with the positioning groove and facing forward, the positioning groove cooperates with the opening to define a structure having a small entry and a big body, and a diameter of the small entry is smaller than a diameter of the big body. The hanging portion comprises a head portion and a neck portion secured to the head portion and a rear surface of the hanging device, the head portion cooperates with and is connected to the positioning groove, and the neck portion cooperates with and is connected to the opening.

In an embodiment, the one or more positioning mechanisms comprise two positioning mechanisms, the two positioning mechanisms are disposed in the wall mount bracket, and the two positioning mechanisms are disposed left and right and are separated from each other.

In an embodiment, the positioning member is configured to be slidably connected to the hanging groove back and forth. When the positioning member is in the positioned state, the positioning member penetrates a bottom of the positioning groove to be disposed in the positioning groove, and the positioning member cooperates with the head portion to achieve a hanging function.

In an embodiment, the positioning member is configured to be slidably connected to the hanging groove left and right. When the positioning member is in the positioned state, the positioning member penetrates a groove wall of the positioning groove to be disposed in the positioning groove, and the positioning member cooperates with the head portion to achieve a hanging function.

In an embodiment, at least one of an end of the positioning member or a bottom wall of the head portion is disposed with a guiding surface, and a guiding mechanism comprises the guiding surface.

In an embodiment, the end of the positioning member is a ball head, and a ball wall of the ball head defines the guiding surface.

In an embodiment, an outer peripheral wall of the head portion is an outer rotating wall, and the outer rotating wall defines the guiding surface.

In an embodiment, the wall mount bracket comprises a wall mount bracket body and a wall mount bracket outer cover, and the wall mount bracket outer cover is secured to the wall mount bracket body. The wall mount bracket outer cover comprises the hanging groove. The wall mount bracket outer cover comprises a mounting hole penetrating back and forth, and the positioning member is slidably connected to an inner side of the mounting hole. The elastic body is disposed in the mounting hole, a first end of the elastic body abuts the positioning member, and a second end of the elastic body abuts the wall mount bracket body.

In an embodiment, a portion of the opening is disposed with an enlarged opening disposed above the one or more positioning mechanisms, and the head portion is configured to be disposed in or be separated from the hanging groove through the enlarged opening. When the hanging device is disposed in the wall mount bracket, a center of the enlarged opening is higher than a center of the head portion supported on the positioning member.

Compared with the existing techniques, the technical solution has the following advantages.

The positioning member of the one or more positioning mechanisms can position the hanging device, which can bear the weight of the hanging device to function in positioning role to enable the hanging device to be positioned on the wall mount bracket. When the hanging device is pulled out, the positioning member will move from the positioned state to the relief state, so that the user can upwardly pull out the hanging device or downwardly pull out the hanging device, so that the hanging device can be upwardly or downwardly removed, and a function of being able to remove the hanging device in multiple directions is achieved.

The wall mount bracket device is disposed with a guiding mechanism, so that the user can upwardly pull out the hanging device or downwardly pull out the hanging device by overcoming the elastic force of the elastic body or the elastic force of the positioning member to enable the positioning member to move to the relief state. The hanging device can be upwardly or downwardly pulled out, the function of being able to remove the hanging device in multiple directions is achieved, and the positioning member is reset to the positioned state after the hanging device is removed.

Two positioning mechanisms are disposed in the wall mount bracket. The two positioning mechanisms are disposed left and right and are separated from each other, and the positioning is firm and stable.

The positioning member can be slidably connected to the wall mount bracket back and forth. The positioning member disposed in the positioning state passes through the bottom of the positioning groove to be disposed in the positioning groove. The positioning member disposed in the extended position and the head portion are supported by each other. The structure is simple and compact.

The positioning member is slidably connected to the inner side of the mounting hole, and the elastic body is disposed in the mounting hole. The first end of the elastic body abuts the positioning member, and the second end of the elastic body abuts the wall mount bracket body. The structure is simple and compact.

### BRIEF DESCRIPTION OF THE DRAWINGS

The present disclosure will be further described below in combination with the accompanying drawings and embodiments.

FIG. 1 illustrates a perspective view of a wall mount bracket device of Embodiment 1.

FIG. 2 illustrates an exploded view of the wall mount bracket device of Embodiment 1.

FIG. 3 illustrates a front partial cross-sectional view of the wall mount bracket device of Embodiment 1.

FIG. 4 illustrates a perspective view of Embodiment 1 when a hanging device is separated from a wall mount bracket, in which an arrow represents a placing direction.

FIG. 5 illustrates a partial cross-sectional view of Embodiment 1 when the hanging device is hung on the wall mount bracket, in which an arrow represents a removing direction.

FIG. 6 illustrates a perspective view of the hanging device of Embodiment 1.

FIG. 7 illustrates a first perspective view of the wall mount bracket of Embodiment 1.

FIG. 8 illustrates a second perspective view of the wall mount bracket of Embodiment 1.

FIG. 9 illustrates a schematic view of a hanging structure of Embodiment 1.

FIG. 10 illustrates a schematic view of a hanging structure of Embodiment 2.

FIG. 11 illustrates a schematic view of a hanging structure of Embodiment 3.

FIG. 12 illustrates a schematic view of a hanging structure of Embodiment 4.

FIG. 13 illustrates a schematic view of a hanging structure of Embodiment 5.

### DETAILED DESCRIPTION OF THE EMBODIMENTS

### Embodiment 1

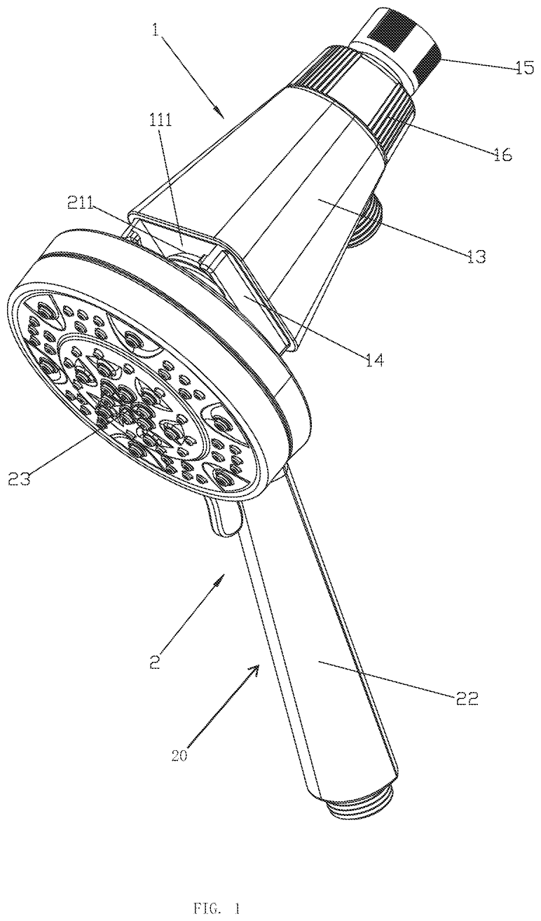

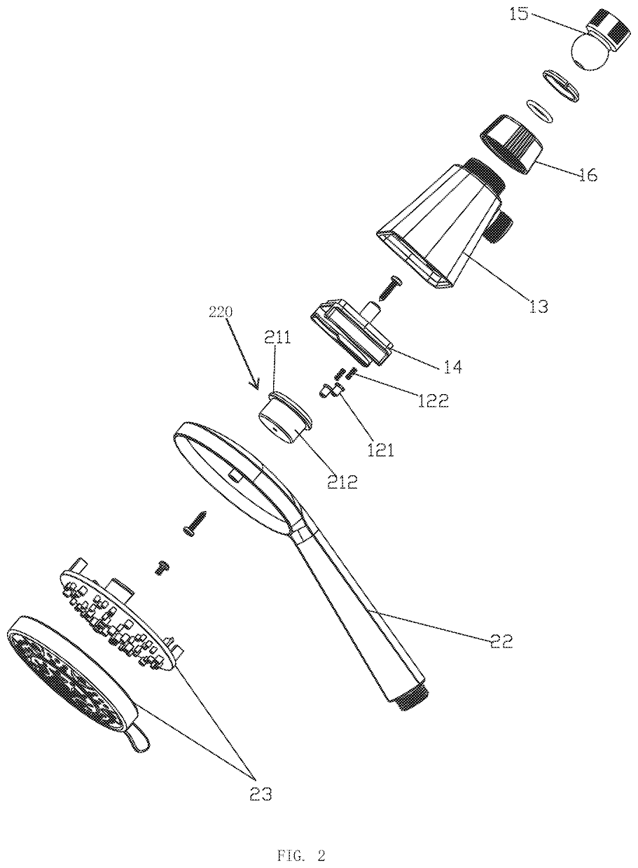

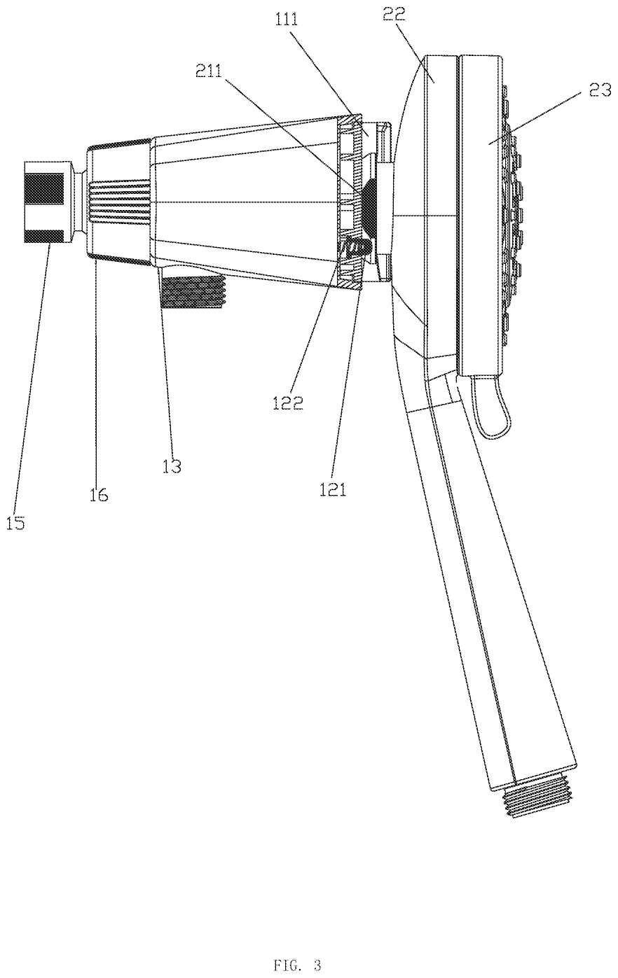

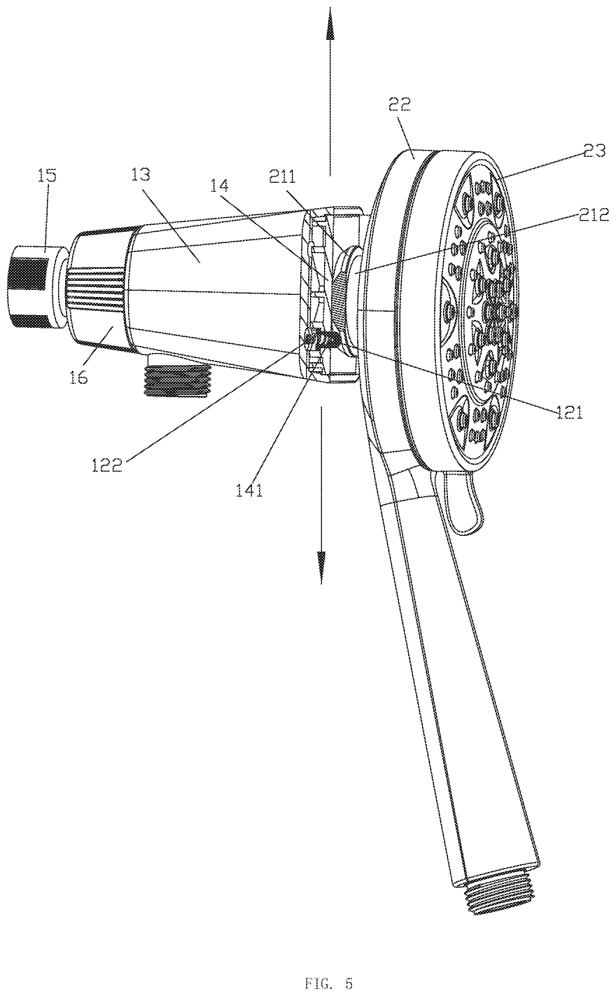

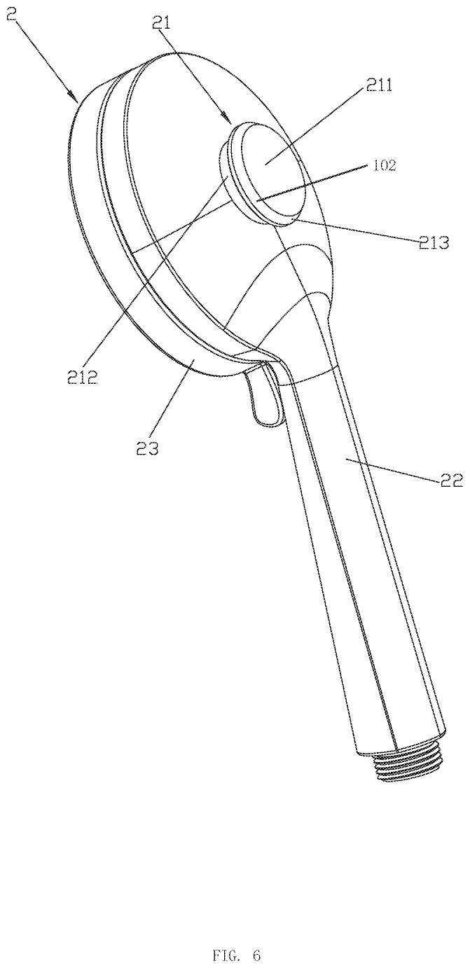

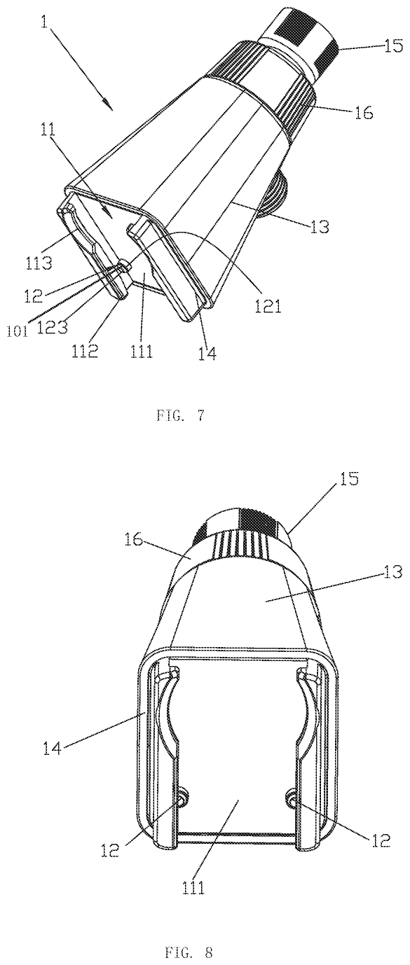

Referring to FIGS. 1-9, a wall mount bracket device configured to remove a hanging device in multiple directions comprises a wall mount bracket 1 and a hanging device 2. The hanging device 2 is, for example, a hand-held shower 20. A hanging structure is disposed between the wall mount bracket 1 and the hanging device 2, and the hanging structure comprises a hanging groove 11 and a hanging portion 21.

The hanging groove 11 is penetrated up and down (i.e., in a vertical direction) and is disposed on the wall mount bracket 1. The hanging groove 11 comprises a positioning groove 111 and an opening 112 configured to be in communication with the positioning groove 111 and face forward. The positioning groove 111 and the opening 112 cooperate to define a structure having a small entry and a big body, and a diameter of the small entry is smaller than a diameter of the big body. A portion of the opening 112 is disposed with an enlarged opening 113 disposed above one or more positioning mechanisms 12.

The one or more positioning mechanisms 12 comprise one or more positioning members 121 and one or more elastic bodies 122. The one or more positioning members 121 are configured to move between an extended position disposed in the hanging groove 11 and a retracted position that retract the extending relative to the wall mount bracket 1. The one or more elastic bodies 122 abut the one or more positioning members 121 to enable the one or more positioning members 121 to be disposed in the hanging groove 11 due to an elastic force of the one or more elastic bodies 122. When the one or more positioning members 121 are in the extended position, the one or more positioning members 121 are in a positioned state. When the one or more positioning members 121 are in the retracted position, the one or more positioning members 121 are in a relief state. In this embodiment, the one or more positioning members 121 are configured to be slidably connected to the wall mount bracket 1 back and forth. The one or more positioning members 121, when disposed in the extended position, pass through a bottom of the positioning groove 111 in a forward direction to be disposed in the positioning groove 111. Two positioning mechanisms 12 of the one or more positioning mechanisms are disposed in the wall mount bracket 1, and the two positioning mechanisms 12 are disposed left and right (i.e., in a lateral direction) and separated from each other. In some embodiments, the wall mount bracket 1 comprises a wall mount bracket body 13 and a wall mount bracket outer cover 14. The wall mount bracket outer cover 14 is secured to the wall mount bracket body 13, and the securing is, for example, securing by a screw. The wall mount bracket outer cover 14 comprises the hanging groove 11, and the wall mount bracket outer cover 14 comprises one or more mounting holes 141 penetrating the wall mount bracket outer cover 14 in the forward direction and a rearward direction. The one or more positioning members 121 are slidably connected to inner sides of the one or more mounting holes 141, and the one or more elastic bodies 122 are disposed in the one or more mounting holes 141. The one or more elastic bodies 122 are, for example, springs, and the one or more elastic bodies 122 are disposed in the one or more mounting holes 141. First ends of the one or more springs abut concave grooves of rear surfaces of the one or more positioning members 121, and second ends of the one or more springs abut the wall mount bracket body 13. The wall mount bracket body 13 is secured to a wall through a ball head 15 and a screw nut 16. As required, the wall mount bracket 1 can be disposed with a water inlet passage configured to be in communication with a water source, and the hand-held shower 20 is in communication with the water inlet passage through a hose.

A rear surface of the hanging device 2 protrudes to define the hanging portion 21. The hanging portion 21 comprises a head portion 211 and a neck portion 212 secured to the head portion 211 and the rear surface of the hanging device 2. The head portion 211 cooperates with and is connected to the positioning groove 111. The neck portion 212 cooperates with and is connected to the opening 112, and the hanging portion 21 cooperates with the hanging groove 11 to move up and down along the hanging groove 11. The hanging portion 21 is slidably disposed in the hanging groove 11, and the one or more positioning members 121, when disposed in the extended position, are configured to support the head portion 211 to enable the hanging device 2 to be positioned on the wall mount bracket 1 (i.e., prevent the hand-held shower 20 from falling downward under a weight of the hanging device). The hanging device 2 comprises a shower body 22 and a water outlet cover 23 configured to be assembled to the shower body 22, and water spray can be switched through the water outlet cover 23. A rear side of the shower body 22 is secured to a connecting portion 220. The connecting portion 220 partially extends out of a rear surface of the shower body 22, and the extended portion of the connecting portion 220 defines the hanging portion 21.

A guiding mechanism 100 is disposed between the hanging portion 21 and the one or more positioning members 121. When the hanging device 2 is downwardly pulled out, the guiding mechanism 100 is configured to abut the one or more positioning members 121 to move from the extended position to the retracted position. After the one or more positioning members 121 are retracted by overcoming the elastic force of the one or more elastic bodies 122, the hanging device 2 is downwardly pulled out, so that the hanging device 2 can be removed even in a downward direction. Moreover, as the head portion 211 cooperates with the hanging groove 11, when other directional forces are applied (that is, except for in an upward direction and the downward direction), two side walls of the hanging groove 11 interact with the hanging portion 21 of the hand-held shower 20 to perform a self-lock function and to prevent the hand-held shower 20 from falling downward due to accidental application force.

At least one of ends of the one or more positioning members 121 or a bottom wall of the head portion 211 is disposed with guiding surfaces 101 or 102, and the guiding mechanism 100 comprises the guiding surface. Ends of the one or more positioning members 121 are ball head ends 123, and ball walls of the ball head ends 123 define first guiding surfaces 101. An outer peripheral wall of the head portion 211 defines an outer rotating wall 213, and the outer rotating wall defines a second guiding surface 102.

In this embodiment, the head portion 211 is configured to be disposed in or separated from the hanging groove 11 through the enlarged opening 113, and a center of the enlarged opening 113 is higher than a center of the head portion 211 supported by the one or more positioning members 121 when the hanging device 2 is disposed the wall mount bracket 1.

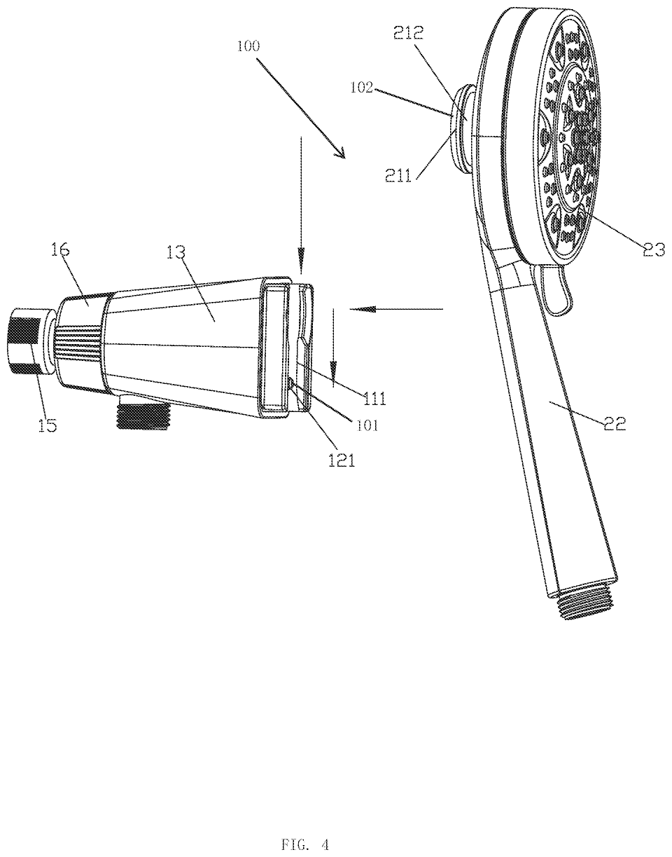

The wall mount bracket device of this embodiment functions as follows. After the hand-held shower 20 is disposed on the wall mount bracket 1, the hand-held shower 20 is positioned by the one or more positioning members 121 of the one or more positioning mechanisms 12 to ensure that the hand-held shower 20 is positioned and hung on the wall mount bracket 1. When the hand-held shower 20 is placed, referring to FIG. 4, the hand-held shower 20 can be placed in two directions. As a first direction, the hand-held shower 20 is directly placed in a downward direction, and as a second direction, the hand-held shower 20 firstly enters into the wall mount bracket 1 through a circular guide trail (i.e., the enlarged opening 113), and then the hand-held shower 20 is downwardly placed. When the hand-held shower 20 is removed, the hand-held shower 20 can be taken out in two directions, referring to FIG. 5. When the hand-held shower 20 is upwardly taken out, the hand-held shower 20 is directly taken out along an upward direction parallel to the wall mount bracket 1. When the hand-held shower 20 is downwardly taken out, the hand-held shower 20 is subjected to a downward force parallel to the wall mount bracket 1. A head portion of the hand-held shower 20 will inwardly abut the one or more positioning members 121 to move to the retracted position due to an action of the downward force. A positioning of the one or more positioning members 121 is released, and then the hand-held shower 20 can be downwardly taken out.

### Embodiment 2

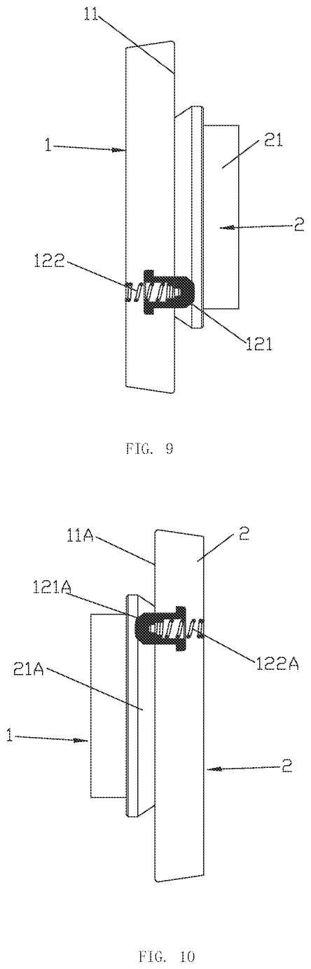

Referring to FIG. 10, this embodiment differs from Embodiment 1 in that: the rear surface of the hanging device 2 comprising a hanging groove 11A penetrating up and down. A structure of the hanging groove 11A is the same as a structure of the hanging groove 11 of Embodiment 1. A front surface of the wall mount bracket 1 protrudes to define a hanging portion 21A, and a structure of the hanging portion 21A is the same as the hanging portion 21 of Embodiment 1. The one or more positioning mechanisms 12 comprise a positioning member 121A and an elastic body 122A. The one or more positioning mechanisms 12 are disposed in the hanging device 2, and the positioning member 121A is configured to be disposed in the hanging groove 11A due to the elastic body 122A abutting the positioning member 121A. The positioning member 121A, when disposed in the positioned state, is supported by and is hung on the hanging portion 21A to position the hand-held shower 20. When the hand-held shower 20 is downwardly pulled out, the guiding mechanism 100 between the positioning member 121A and the hanging portion 21A is configured to enable the positioning member 121A to be retracted, so that the hand-held shower 20 can be downwardly pulled out.

### Embodiment 3

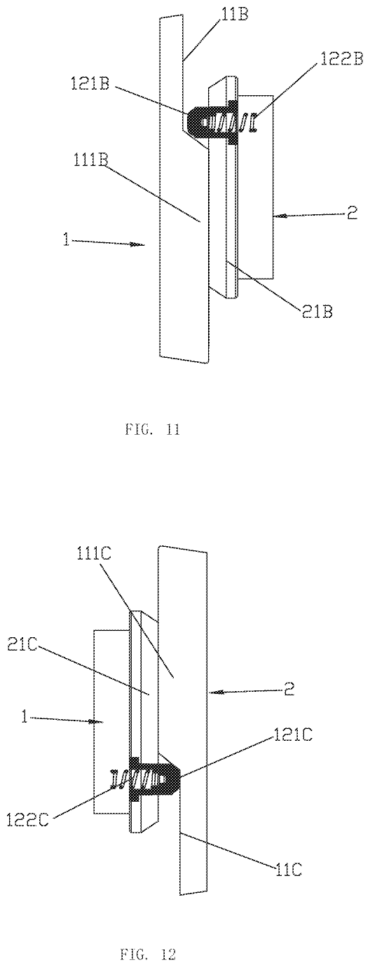

Referring to FIG. 11, this embodiment differs from Embodiment 1 in that: the one or more positioning mechanisms 12 comprise a positioning member 121B and an elastic body 122B. The one or more positioning mechanisms 12 are disposed in the hanging device 2, and the positioning member 121B is configured to extend out of a rear surface of the hanging portion 21 due to the elastic body 122B abutting the positioning member 121B. A bottom of the hanging groove 11B protrudes to define a protrusion 111B disposed in the hanging groove 11B. The positioning member 121B, when disposed in the positioning state, is supported by and is hung on the protrusion 111B to position the hand-held shower 20. When the hand-held shower 20 is downwardly pulled out, the guiding mechanism 100 between the positioning member 121B and the protrusion 111B is configured to enable the positioning member 121B to be retracted, so that the hand-held shower 20 can be downwardly pulled out.

### Embodiment 4

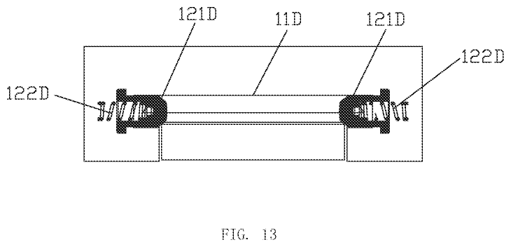

Referring to FIG. 12, this embodiment differs from Embodiment 3 in that: the rear surface of the hanging device 2 is disposed with a hanging groove 11C penetrating up and down, and the wall mount bracket 1 protrudes to define a hanging portion 21C. The one or more positioning mechanisms 12 comprise a positioning member 121C and an elastic body 122C. The one or more positioning mechanisms 12 are disposed in the wall mount bracket 1, and the positioning member 121C is configured to be disposed in the hanging groove 11C due to the elastic body 122C abutting the positioning member 121C. The bottom of the hanging groove 11C protrudes to define a protrusion 111C disposed in the hanging groove 11C. The positioning member 121B, when disposed in the positioning state, supports and is hung with the protrusion 111C to position the hand-held shower 20. When the hand-held shower 20 is downwardly pulled out, the guiding mechanism 100 between the positioning member 121C and the hanging portion 21C is configured to enable the positioning member 121C to be retracted, so that the hand-held shower 20 is downwardly pulled out.

### Embodiment 5

Referring to FIG. 13, this embodiment differs from Embodiment 1 in that the one or more positioning mechanisms 12 comprise a positioning member 121D and an elastic body 122D. The positioning member 121D is configured to be slidably connected to a hanging groove 11D of the wall mount bracket 1 left and right. The positioning member 121D, when disposed in the positioned state, passes through a groove wall of the hanging groove 11D to be disposed in the hanging groove 11D, and the positioning member 121D, when disposed in the positioned state, cooperates with the head portion 211 to achieve a hanging function.

### Embodiment 6

This embodiment differs from Embodiments 1-5 in that: the one or more positioning members 121 have an elastic property, for example, a first end of the one or more positioning members 121 is secured (i.e., is secured to the wall mount bracket 1 or the hanging device 2), and a second end of the one or more positioning members 121 is suspended, so that the one or more positioning members 121 themselves have the elastic property to enable the one or more positioning members 121 to be configured to be switched between the positioned state and the relief state.

The aforementioned embodiments are merely some embodiments of the present disclosure, and the scope of the disclosure is not limited thereto. Thus, it is intended that the present disclosure cover any modifications and variations of the presently presented embodiments provided they are made without departing from the appended claims and the specification of the present disclosure.

What is claimed is:

1. A wall mount bracket device in which a hanging device is configured to be removed in multiple directions, comprising:
a wall mount bracket,
a hanging device, and
one or more positioning mechanisms, wherein:
a hanging structure is disposed between the wall mount bracket and the hanging device,
the hanging structure comprises a hanging groove penetrating up and down,
the hanging structure comprises a hanging portion protruding outward,
the hanging portion cooperates with the hanging groove to enable the hanging portion and the hanging groove to move relative to each other up and down,
the one or more positioning mechanisms comprise a positioning member,
the positioning member is configured to move between a positioned state and a relief state due to an elastic force of the positioning member or an elastic body,
when the positioning member is in the positioned state, the positioning member prevents the hanging device from falling downward under a weight of the hanging device, and
when the positioning member is in the relief state, the hanging device is configured to move downward relative to the wall mount bracket.

2. The wall mount bracket device in which a hanging device is configured to be removed in multiple directions according to claim 1, wherein:
the hanging groove is disposed on the wall mount bracket, and
a rear surface of the hanging device protrudes to define the hanging portion.

3. The wall mount bracket device in which a hanging device is configured to be removed in multiple directions according to claim 1, wherein:
the hanging groove is disposed on a rear surface of the hanging device, and
a front surface of the wall mount bracket protrudes to define the hanging portion.

4. The wall mount bracket device in which a hanging device is configured to be removed in multiple directions according to claim 2, wherein:
the positioning member is disposed on the hanging groove, and
when the positioning member is in the positioned stated:
the positioning member is disposed in the hanging groove, and
the positioning member cooperates with the hanging portion to prevent the hanging device from falling downward under the weight of the hanging device.

5. The wall mount bracket device in which a hanging device is configured to be removed in multiple directions according to claim 2, wherein:
the positioning member is disposed on the hanging device,
the hanging groove comprises a protrusion, and
when the positioning member is in the positioned state, the positioning member cooperates with the protrusion to prevent the hanging device from falling downward under the weight of the hanging device.

6. The wall mount bracket device in which a hanging device is configured to be removed in multiple directions according to claim 1, wherein the positioning member is configured to be elastically deformed to enable the positioning member to be reset from the relief state to the positioned state.

7. The wall mount bracket device in which a hanging device is configured to be removed in multiple directions according to claim 1, wherein:
the one or more positioning mechanisms comprise the elastic body, and
the elastic body abuts the positioning member to enable the positioning member to move to the positioned state due to the elastic force of the elastic body.

8. The wall mount bracket device in which a hanging device is configured to be removed in multiple directions according to claim 1, comprising:
a guiding mechanism, wherein:
when the hanging device is downwardly pulled out, the positioning member moves from the positioned state to the relief state due to the guiding mechanism.

9. The wall mount bracket device in which a hanging device is configured to be removed in multiple directions according to claim 8, wherein:
the positioning member is disposed on the wall mount bracket, and
the guiding mechanism is disposed between the hanging device and the positioning member.

10. The wall mount bracket device in which a hanging device is configured to be removed in multiple directions according to claim 8, wherein:
the positioning member is disposed on the hanging device, and
the guiding mechanism is disposed between the wall mount bracket and the positioning member.

11. The wall mount bracket device in which a hanging device is configured to be removed in multiple directions according to claim 1, wherein:
the hanging groove comprises a positioning groove and an opening in communication with the positioning groove and facing forward,
the positioning groove cooperates with the opening to define a structure having a small entry and a big body,
a diameter of the small entry is smaller than a diameter of the big body,
the hanging portion comprises a head portion and a neck portion secured to the head portion and a rear surface of the hanging device,
the head portion cooperates with and is connected to the positioning groove, and
the neck portion cooperates with and is connected to the opening.

12. The wall mount bracket device in which a hanging device is configured to be removed in multiple directions according to claim 11, wherein:
the one or more positioning mechanisms comprise two positioning mechanisms,
the two positioning mechanisms are disposed in the wall mount bracket, and
the two positioning mechanisms are disposed left and right and are separated from each other.

13. The wall mount bracket device in which a hanging device is configured to be removed in multiple directions according to claim 11, wherein:
the positioning member is configured to be slidably connected to the hanging groove back and forth, and
when the positioning member is in the positioned state:
the positioning member penetrates a bottom of the positioning groove to be disposed in the positioning groove, and
the positioning member cooperates with the head portion to achieve a hanging function.

14. The wall mount bracket device in which a hanging device is configured to be removed in multiple directions according to claim 11, wherein:
the positioning member is configured to be slidably connected to the hanging groove left and right,
when the positioning member is in the positioned state:
the positioning member penetrates a groove wall of the positioning groove to be disposed in the positioning groove, and
the positioning member cooperates with the head portion to achieve a hanging function.

15. The wall mount bracket device in which a hanging device is configured to be removed in multiple directions according to claim 11, wherein:
at least one of an end of the positioning member or a bottom wall of the head portion is disposed with a guiding surface, and
a guiding mechanism comprises the guiding surface.

16. The wall mount bracket device in which a hanging device is configured to be removed in multiple directions according to claim 15, wherein:
the end of the positioning member is a ball head, and
a ball wall of the ball head defines the guiding surface.

17. The wall mount bracket device in which a hanging device is configured to be removed in multiple directions according to claim 15, wherein:
an outer peripheral wall of the head portion is an outer rotating wall, and
the outer rotating wall defines the guiding surface.

18. The wall mount bracket device in which a hanging device is configured to be removed in multiple directions according to claim 13, wherein:
the wall mount bracket comprises a wall mount bracket body and a wall mount bracket outer cover,
the wall mount bracket outer cover is secured to the wall mount bracket body,
the wall mount bracket outer cover comprises the hanging groove,
the wall mount bracket outer cover comprises a mounting hole penetrating back and forth,
the positioning member is slidably connected to an inner side of the mounting hole,
the elastic body is disposed in the mounting hole,
a first end of the elastic body abuts the positioning member, and
a second end of the elastic body abuts the wall mount bracket body.

19. The wall mount bracket device in which a hanging device is configured to be removed in multiple directions according to claim 11, wherein:
a portion of the opening is disposed with an enlarged opening disposed above the one or more positioning mechanisms,
the head portion is configured to be disposed in or be separated from the hanging groove through the enlarged opening, and
when the hanging device is disposed in the wall mount bracket, a center of the enlarged opening is higher than a center of the head portion supported on the positioning member.

20. The wall mount bracket device in which a hanging device is configured to be removed in multiple directions according to claim 3, wherein:
the positioning member is disposed on the hanging groove, and
when the positioning member is in the positioned stated:
the positioning member is disposed in the hanging groove, and
the positioning member cooperates with the hanging portion to prevent the hanging device from falling downward under the weight of the hanging device.
